(19) United States
(12) Patent Application Publication
(10) Pub. No.: US 2026/0197887 A1
(43) Pub. Date: Jul. 9, 2026

(54) APPARATUS AND METHOD FOR SUPPORTING MULTIPLE MULTI-PATH QUIC PROTOCOLS IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Chang Ki KIM, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 19/443,524

(22) Filed: Jan. 8, 2026

(30) Foreign Application Priority Data
Jan. 9, 2025 (KR) 10-2025-0003221
Jan. 15, 2025 (KR) 10-2025-0006047
Dec. 29, 2025 (KR) 10-2025-0212387

(51) Int. Cl. H04W 76/15

(52) U.S. Cl. CPC H04W 76/15

(57) ABSTRACT

A method and apparatus for supporting multiple Multi-Path Quick UDP Internet Connections (QUIC) protocols in a wireless communication system are provided. A session management function (SMF) receives access traffic steering capability information from a user terminal, identifying support for protocols such as ATSSS Low-Layer, Multi-Path TCP (MPTCP), MPQUIC-UDP, MPQUIC-IP, or MPQUIC-E. The SMF determines an access traffic steering functionality to be provided to the user terminal based on at least one of a Protocol Data Unit (PDU) session type, a User Equipment (UE) capability and network capability. The SMF then provides a corresponding access traffic steering parameter to the user terminal. This enables optimized multiple access traffic processing by selectively applying appropriate MPQUIC protocols according to the PDU session type.

### CROSS-REFERENCE TO RELATED APPLICATIONS

This application claims priority under 35 U.S.C. § 119 to Korean Patent Application No. 10-2025-0003221, filed on January 9, 2025, Korean Patent Application No. 10-2025-0006047, filed on January 15, 2025, and Korean Patent Application No. 10-2025-0212387, filed on December 29, 2025, in the Korean Intellectual Property Office, the disclosures of which are incorporated herein by reference in their entirety.

### BACKGROUND OF THE INVENTION

### Field of the Invention

The present disclosure generally relates to a wireless communication system, and more specifically, to an apparatus and method for supporting multiple Multi-Path Quick UDP Internet Connections (QUIC) protocols in a wireless communication system.

### Description of the Related Art

Conventional Access Traffic Steering, Switching, Splitting (ATSSS) supports Multi-Path Transmission Control Protocol (MPTCP), Multi-Path Quick UDP Internet Connections (MPQUIC), MPQUIC (Multi-Path Quick UDP Internet Connections (QUIC)), and ATSSS Low-Layer (ATSSS-LL) for steering, switching, and splitting of traffic for 3rd Generation Partnership Project (3GPP) access and Non-3GPP access. ATSSS is a technology for efficiently managing user traffic, providing functions to coordinate and optimize traffic between 3GPP access and Non-3GPP access. Steering is a function of selecting an access network to be used for new traffic, Switching is a function of changing an access network for traffic currently in service, and Splitting is a function of distributing and using one or more access networks for traffic currently in service.

The MPQUIC of the conventional ATSSS is limited to MPQUIC-UDP. MPQUIC can be subdivided into MPQUIC-UDP, MPQUIC-IP, and MPQUIC-E according to the supported protocols, which support User Datagram Protocol (UDP), Internet Protocol (IP), and Ethernet protocol, respectively. However, in the prior art, there is a problem that suitable MPQUIC protocols cannot be distinguished and used according to the Protocol Data Unit (PDU) session type. In particular, although different MPQUIC protocols are required for an IP type PDU session and an Ethernet type PDU session, there is no mechanism to distinguish and support them.

In addition, extensions of Non-Access Stratum (NAS) messages, Packet Forwarding Control Protocol (PFCP) messages, and Service Based Interface (SBI) protocols are required to exchange multiple MPQUIC protocol information between a User Equipment (UE), a Session Management Function (SMF), a Policy Control Function (PCF), and a User Plane Function (UPF). Therefore, there is a need for a technology that clearly distinguishes and supports MPQUIC-UDP, MPQUIC-IP, and MPQUIC-E in an ATSSS environment, and selectively applies an appropriate MPQUIC protocol according to a PDU session type.

### SUMMARY OF THE INVENTION

Based on the discussion above, the present disclosure provides an apparatus and method for distinguishing and supporting MPQUIC-UDP (Multi-Path QUIC - UDP), MPQUIC-IP (Multi-Path QUIC - IP), and MPQUIC-E (Multi-Path QUIC - Ethernet) in an Access Traffic Steering, Switching, Splitting (ATSSS) environment in a wireless communication system. In addition, the present disclosure provides an apparatus and method for selectively applying an appropriate MPQUIC protocol according to a Protocol Data Unit (PDU) session type in a wireless communication system. In addition, the present disclosure provides an apparatus and method for delivering multiple MPQUIC protocol information through a Non-Access Stratum (NAS) message, a Packet Forwarding Control Protocol (PFCP) message, and a Service Based Interface (SBI) protocol in a wireless communication system.

According to various embodiments of the present disclosure, a session management function for supporting multiple multi-path QUIC protocols in a wireless communication system may receive information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as an access traffic steering capability or an access traffic steering protocol configuration option from a user terminal; determine an access traffic steering functionality to be provided to the user terminal by considering at least one of a protocol data unit session type, a UE (User Equipment) capability and a capability of a network; and provide an access traffic steering parameter corresponding to the determined access traffic steering functionality to the user terminal.

According to various embodiments of the present disclosure, an operating method of a session management function for supporting multiple multi-path QUIC protocols in a wireless communication system may include: receiving information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as an access traffic steering capability or an access traffic steering protocol configuration option from a user terminal; determining an access traffic steering functionality to be provided to the user terminal by considering at least one of a protocol data unit session type, a UE (User Equipment) capability and a capability of a network; and providing an access traffic steering parameter corresponding to the determined access traffic steering functionality to the user terminal.

According to various embodiments of the present disclosure, a user terminal for supporting multiple multi-path QUIC protocols in a wireless communication system may transmit access traffic steering capability information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as supportable access traffic steering functionalities to a session management function; receive an access traffic steering parameter from the session management function; and perform traffic steering, switching, or splitting between a 3GPP access and a Non-3GPP access based on the access traffic steering parameter.

According to various embodiments of the present disclosure, an operating method of a user terminal for supporting multiple multi-path QUIC protocols in a wireless communication system may include: transmitting access traffic steering capability information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as supportable access traffic steering functionalities to a session management function; receiving an access traffic steering parameter from the session management function; and performing traffic steering, switching, or splitting between a 3GPP access and a Non-3GPP access based on the access traffic steering parameter.

The apparatus and method according to various embodiments of the present disclosure enable optimized multiple access traffic processing according to the PDU data type by subdividing and supporting conventional MPQUIC into MPQUIC-UDP, MPQUIC-IP, and MPQUIC-E. In addition, the apparatus and method according to various embodiments of the present disclosure can ensure consistency of the protocol stack and improve network efficiency by applying MPQUIC-UDP or MPQUIC-IP to an IP (Internet Protocol) type PDU session and applying MPQUIC-E to an Ethernet type PDU session. The effects obtainable from the present disclosure are not limited to the above-mentioned effects, and other effects not mentioned will be clearly understood by those skilled in the art to which the present disclosure pertains from the following description.

Effects obtainable from the present disclosure are not limited to the effects mentioned above, and other effects not mentioned will be clearly understood by those skilled in the art to which the present disclosure pertains from the description below.

### BRIEF DESCRIPTION OF THE DRAWINGS

FIG. 1 is a diagram illustrating a network structure supporting access traffic steering according to an embodiment of the present disclosure.

FIG. 2 is a diagram illustrating a protocol data unit session establishment procedure according to an embodiment of the present disclosure.

FIG. 3 is a flowchart illustrating an operating method of a session management function according to an embodiment of the present disclosure.

FIG. 4 is a flowchart illustrating an operating method of a user terminal according to an embodiment of the present disclosure.

FIG. 5 is a block diagram illustrating a configuration of a session management function according to an embodiment of the present disclosure.

FIG. 6 is a block diagram illustrating a configuration of a user terminal according to an embodiment of the present disclosure.

### DETAILED DESCRIPTION OF THE EMBODIMENTS

Terms used in the present disclosure are used only to describe specific embodiments and may not be intended to limit the scope of other embodiments. Singular expressions may include plural expressions unless the context clearly indicates otherwise. Terms used herein, including technical or scientific terms, may have the same meaning as generally understood by those skilled in the art described in the present disclosure. Terms defined in a general dictionary among terms used in the present disclosure may be interpreted as having the same or similar meaning as the meaning in the context of the related art, and are not interpreted as having an ideal or excessively formal meaning unless clearly defined in the present disclosure. In some cases, even terms defined in the present disclosure cannot be interpreted to exclude embodiments of the present disclosure.

Various embodiments of the present disclosure described below describe a hardware approach as an example. However, since various embodiments of the present disclosure include technology using both hardware and software, various embodiments of the present disclosure do not exclude a software-based approach. Also, in the detailed description and claims of the present disclosure, "at least one of A, B, and C" may mean "only A", "only B", "only C", or "any combination of A, B, and C". Also, "at least one of A, B, or C" or "at least one of A, B, and/or C" may mean "at least one of A, B, and C".

Hereinafter, the present disclosure relates to an apparatus and method for supporting multiple multi-path QUIC protocols in a wireless communication system. Specifically, the present disclosure describes a technology for distinguishing and supporting Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) in a wireless communication system.

Terms referring to signals, terms referring to channels, terms referring to control information, terms referring to network entities, terms referring to components of an apparatus, and the like used in the following description are exemplified for convenience of description. Therefore, the present disclosure is not limited to the terms described below, and other terms having equivalent technical meanings may be used. In addition, the present disclosure describes various embodiments using terms used in some communication standards (e.g., 3rd Generation Partnership Project (3GPP)), but this is only an example for description. Various embodiments of the present disclosure may be easily modified and applied to other communication systems.

### Key terms used in the present disclosure are defined as follows.

Access Traffic Steering, Switching, Splitting (ATSSS): Access traffic steering is a technology for efficiently managing user traffic, coordinating and optimizing traffic between 3GPP access and Non-3GPP access, and providing functions of steering, switching, and splitting. Steering is a function of selecting an access network to be used for new traffic, Switching is a function of changing an access network for traffic currently in service, and Splitting is a function of distributing and using one or more access networks for traffic currently in service. In this specification, "between RANs respectively belonging to two or more different communication networks (PLMNs)" may be expressed as "outside communication network" for convenience.

ATSSS steering functionality: There are ATSSS Low-Layer (ATSSS-LL) operating in the network layer and Multi-Path Transmission Control Protocol (MPTCP), Multi-Path QUIC (MPQUIC), etc., operating in the transport layer to support the access traffic steering functionality. Multi-Path QUIC is divided into Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) according to the supported protocols, supporting User Datagram Protocol (UDP), Internet Protocol (IP), and Ethernet protocols, respectively.

ATSSS steering mode: The ATSSS steering mode consists of Active-Standby, Smallest Delay, Load-Balancing, Priority-based, and Redundant. The ATSSS steering mode is applied for each ATSSS steering functionality. The Active-Standby mode defines Active as a first access network and Standby as a second access network, preferentially uses the first access network, and uses the second access network when the first access network is unavailable. When the first access network becomes available again, the first access network is used. The Smallest Delay mode uses an access network with a smaller Round-Trip Time (RTT) based on performance measurement between the user terminal and the user plane function. If one access network becomes unavailable, the other access network is used. The Load-Balancing mode uses two access networks at a certain ratio respectively. If one access network becomes unavailable, only the other access network is used. The Priority-based mode defines a first access network with high priority and a second access network with low priority, preferentially uses the first access network, and uses the second access network together when the first access network is congested. If the first access network becomes unavailable again, only the second access network is used. The Redundant mode replicates traffic and uses both access networks.

Performance Measurement Functionality (PMF): The performance measurement functionality is a function existing in the user terminal and the user plane function, measuring traffic performance between the user terminal and the user plane function. When MPTCP or MPQUIC is used as the steering functionality, performance can be measured within MPTCP or MPQUIC, but when ATSSS-LL is used, operations according to the steering mode can be performed by using the PMF. The PMF of the user terminal and the user plane function can cooperate to measure Round-Trip Time (RTT), Packet Loss Rate (PLR), and Access Availability/Unavailability.

Measurement Assistance Information: Measurement assistance information is information informing the PMF on the user terminal side of the address, port, etc., of the PMF on the user plane function side. For an Ethernet protocol data unit session, a 3GPP MAC address and a Non-3GPP MAC address are provided respectively, and for an Internet protocol protocol data unit session, a 3GPP Internet protocol address, a Non-3GPP Internet protocol address, a 3GPP port, and a Non-3GPP port are provided respectively. The Internet protocol address provides one or more of IPv4 or IPv6 addresses according to the Internet protocol version of the protocol data unit session.

Multi-Access PDU Session (MA PDU Session): A protocol data unit session capable of using one or more access networks together, which is a protocol data unit session capable of supporting access traffic steering. In the present disclosure, Protocol Data Unit Session and Multi-Access Protocol Data Unit Session are used interchangeably.

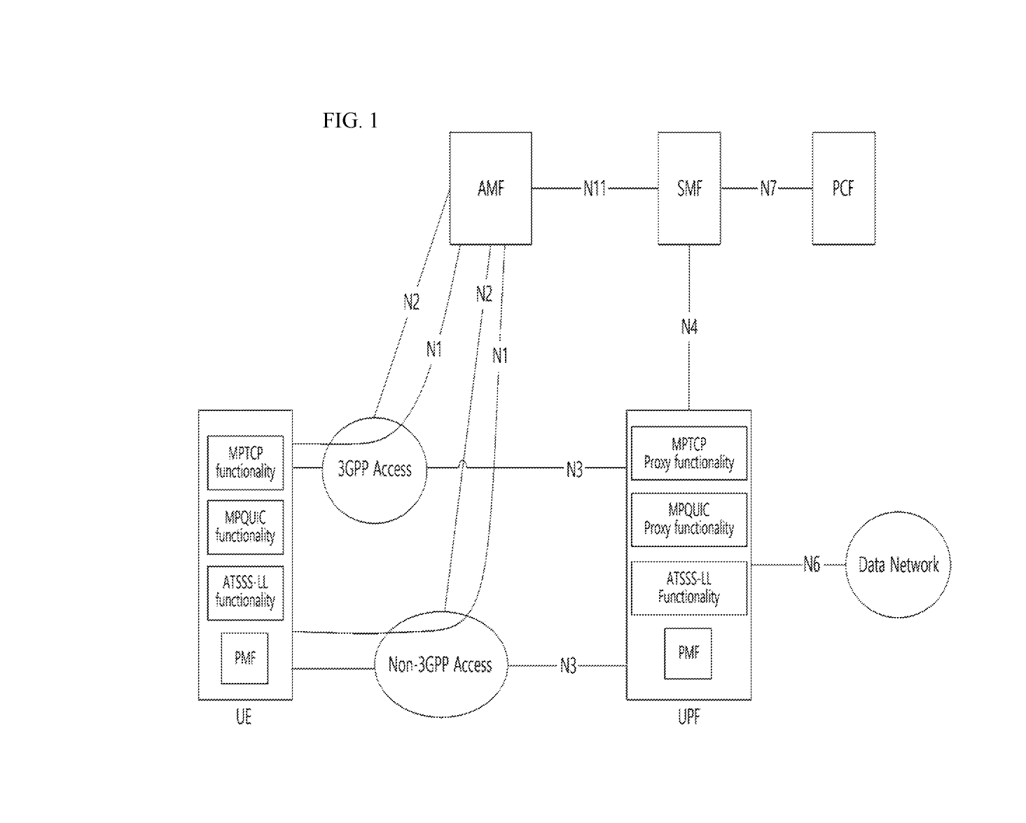

FIG. 1 is a diagram illustrating a network structure supporting access traffic steering according to an embodiment of the present disclosure. Referring to FIG. 1, a network supporting Access Traffic Steering, Switching, Splitting (ATSSS) may include a User Equipment (UE), an Access and Mobility Management Function (AMF), a Session Management Function (SMF), a Policy Control Function (PCF), a User Plane Function (UPF), and a Data Network (DN). Access traffic steering functionalities include ATSSS Low-Layer (ATSSS-LL), Multi-Path TCP (MPTCP), and Multi-Path QUIC (MPQUIC), and MPTCP and MPQUIC use an HTTP proxy function. Multi-Path QUIC (MPQUIC) is further divided into Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) according to the supported protocols. The AMF manages access from the user terminal and delivers session-related NAS (Non-Access Stratum) messages to the SMF. The SMF manages a Protocol Data Unit (PDU) session with the user terminal. The PCF controls policies for the protocol data unit session. The UPF handles user traffic between the user terminal and the data network.

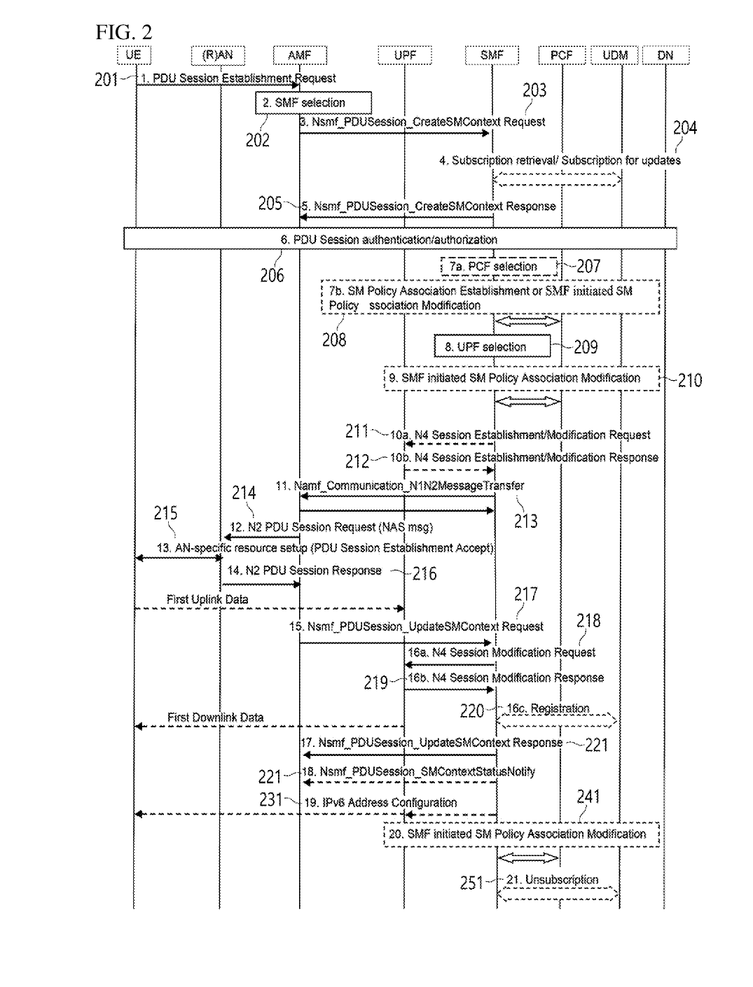

FIG. 2 is a diagram illustrating a protocol data unit session establishment procedure according to an embodiment of the present disclosure. Referring to FIG. 2, a procedure in which a user terminal establishes a Multi-Access PDU Session (MA PDU Session) is shown. This procedure includes message exchange between the User Equipment (UE), (Radio) Access Network ((R)AN), Access and Mobility Management Function (AMF), Session Management Function (SMF), Policy Control Function (PCF), User Plane Function (UPF), Unified Data Management (UDM), and Data Network (DN).

Step 201: Protocol Data Unit Session Establishment Request from User Terminal to Access Management Function The user terminal (UE) transmits a PDU Session Establishment Request or PDU Session Modification Request loaded in a Payload container to the AMF via either 3GPP access or Non-3GPP access in a UL NAS transport. At this time, the Payload container type is set to N1 SM information. By specifying the session identifier as PDU Session ID and MA PDU request as Request type, it can indicate a Multi-Access Protocol Data Unit Session. S-NSSAI indicates network slice information intended to be used by the corresponding protocol data unit session, and DNN indicates a DNN to be used by the corresponding protocol data unit session. If MA PDU session information is set to MA PDU session network upgrade is allowed, it can be requested to upgrade the corresponding protocol data unit session to a multi-access protocol data unit session.

Step 202: Selection of Session Management Function by Access Management Function The AMF selects an SMF capable of supporting the Multi-Access Protocol Data Unit Session.

Step 203: Protocol Data Unit Session Request from Access Management Function to Session Management Function The SMF receives a PDU Session Establishment Request or PDU Session Modification Request, which is a request message for establishing or modifying a Multi-Access Protocol Data Unit Session from the user terminal. The PDU session ID included in the PDU Session Establishment Request or PDU Session Modification Request is an identifier of the corresponding Multi-Access Protocol Data Unit Session. The PDU session type is a type of the corresponding Multi-Access Protocol Data Unit Session. ATSSS-ST in 5GSM capability provides the access traffic steering capability of the user terminal, and ATSSS-ST included in ATSSS PCO of Extended PCO provides the access traffic steering protocol configuration of the user terminal. ATSSS-ST may be composed of a combination of Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), Multi-Path Quick UDP Internet Connections - Ethernet (MPQUIC-E), and Access Traffic Steering, Switching, Splitting Low-Layer (ATSSS-LL) considering one or more of a multi-access control protocol intended to be used in the PDU Session and a data type intended to be used by the UE in the PDU Session. In addition to the conventionally defined combinations, the following additional combinations are possible: 1: Allow any steering mode as ATSSS-LL function 2: Support any steering mode as MPTCP function and only active-standby steering mode as ATSSS-LL function 3: Support any steering mode as MPTCP function and any steering mode allowed for ATSSS-LL as ATSSS-LL function 4: Support any steering mode as MPQUIC function and only active-standby steering mode as ATSSS-LL function 5: Support any steering mode as MPQUIC function and any steering mode allowed for ATSSS-LL as ATSSS-LL function 6: Support any steering mode as MPTCP function, any steering mode as MPQUIC function, and only active-standby steering mode as ATSSS-LL function 7: Support any steering mode as MPTCP function, any steering mode as MPQUIC function, and any steering mode allowed for ATSSS-LL as ATSSS-LL function

In addition to the existing combinations, more identifiers combining MPTCP, MPQUIC-UDP, MPQUIC-IP, MPQUIC-E, and ATSSS-LL can be added. For example, a combination using MPQUIC-UDP in any steering mode and ATSSS-LL in active-standby mode; a combination using MPQUIC-UDP in any steering mode and ATSSS-LL in any steering mode; a combination using MPTCP in any steering mode, MPQUIC-UDP in any steering mode, and ATSSS-LL in active-standby mode; a combination using MPTCP in any steering mode, MPQUIC-UDP in any steering mode, and ATSSS-LL in any steering mode, etc. are possible. Also, a combination using MPQUIC-IP in any steering mode and ATSSS-LL in active-standby mode; a combination using MPQUIC-IP in any steering mode and ATSSS-LL in any steering mode; a combination using MPTCP in any steering mode, MPQUIC-IP in any steering mode, and ATSSS-LL in active-standby mode; a combination using MPTCP in any steering mode, MPQUIC-IP in any steering mode, and ATSSS-LL in any steering mode are possible. Also, a combination using MPQUIC-UDP in any steering mode, MPQUIC-IP in any steering mode, and ATSSS-LL in active-standby mode; a combination using MPQUIC-UDP in any steering mode, MPQUIC-IP in any steering mode, and ATSSS-LL in any steering mode are possible. Also, a combination using MPTCP in any steering mode, MPQUIC-UDP in any steering mode, MPQUIC-IP in any steering mode, and ATSSS-LL in active-standby mode; a combination using MPTCP in any steering mode, MPQUIC-UDP in any steering mode, MPQUIC-IP in any steering mode, and ATSSS-LL in any steering mode are possible. Also, a combination using MPTCP in any steering mode; a combination using MPQUIC-UDP in any steering mode; a combination using MPQUIC-IP in any steering mode; a combination using MPQUIC-E in any steering mode; and a combination using ATSSS-LL in active-standby mode are possible. Also, a combination using MPQUIC-E in any steering mode and ATSSS-LL in active-standby mode; and a combination using MPQUIC-E in any steering mode and ATSSS-LL in any steering mode are possible. Identifiers signifying the above combinations may be included in the NAS message as numeric identifiers.

Steps 204 to 207: Determination of Access Traffic Steering Capability of Session Management Function The SMF can select an access traffic steering capability (atsssCapa) considering one or more of the PDU session type from the user terminal, ATSSS-ST of 5GSM capability, ATSSS-ST included in ATSSS PCO of Extended PCO, and characteristics of the UPF supporting connection to the corresponding DNN. The characteristics of the UPF supporting connection to the corresponding DNN include one or more of steering functionalities supported by that UPF and functions of the Performance Measurement Functionality (PMF) supported by that UPF, and the characteristics of the UPF may be received from the UPF or may be network configuration information. The SMF determines the access traffic steering capability based on at least one of the steering functionality supported by the UPF supporting connection to the corresponding DNN with respect to the steering functionality supportable by the user terminal in ATSSS-ST of 5GSM capability or ATSSS-ST included in ATSSS PCO of Extended PCO for the PDU session type from the user terminal. When there is no intersection between ATSSS-ST from the user terminal and the steering functionality of the UPF and thus the access traffic steering capability cannot be determined, the corresponding Multi-Access Protocol Data Unit Session establishment request may be accepted as a Single-Access PDU Session establishment rather than a Multi-Access Protocol Data Unit Session, or the corresponding Multi-Access Protocol Data Unit Session establishment request may be rejected.

The access traffic steering capability (atsssCapa) may have additional combinations besides the conventionally defined combinations: ATSSS_LL: Use ATSSS-LL in any steering mode for uplink/downlink MPTCP_ATSSS_LL: Use MPTCP in any steering mode and ATSSS-LL in any steering mode for uplink/downlink MPTCP_ATSSS_LL_WITH_ASMODE_UL: Use MPTCP in any steering mode for uplink/downlink, ATSSS-LL in any steering mode for downlink, and ATSSS-LL in active-standby mode for uplink MPTCP_ATSSS_LL_WITH_EXSDMODE_DL_ASMODE_UL: Use MPTCP in any steering mode for uplink/downlink, ATSSS-LL in any steering mode (excluding smallest delay) for downlink, and ATSSS-LL in active-standby mode for uplink MPTCP_ATSSS_LL_WITH_ASMODE_DLUL: Use MPTCP in any steering mode for uplink/downlink and ATSSS-LL in active-standby mode for uplink/downlink MPQUIC_ATSSS_LL: Use MPQUIC in any steering mode and ATSSS-LL in any steering mode for uplink/downlink MPQUIC_ATSSS_LL_WITH_ASMODE_UL: Use MPQUIC in any steering mode for uplink/downlink, ATSSS-LL in any steering mode for downlink, and ATSSS-LL in active-standby mode for uplink MPQUIC_ATSSS_LL_WITH_EXSDMODE_DL_ASMODE_UL: Use MPQUIC in any steering mode for uplink/downlink, ATSSS-LL in any steering mode (excluding smallest delay) for downlink, and ATSSS-LL in active-standby mode for uplink MPQUIC_ATSSS_LL_WITH_ASMODE_DLUL: Use MPQUIC in any steering mode for uplink/downlink and ATSSS-LL in active-standby mode for uplink/downlink MPTCP_MPQUIC_ATSSS_LL: Use MPTCP in any steering mode, MPQUIC in any steering mode, and ATSSS-LL in any steering mode for uplink/downlink MPTCP_MPQUIC_ATSSS_LL_WITH_ASMODE_UL: Use MPTCP in any steering mode, MPQUIC in any steering mode for uplink/downlink, and ATSSS-LL in active-standby mode for uplink MPTCP_MPQUIC_ATSSS_LL_WITH_EXSDMODE_DL_ASMODE_UL: Use MPTCP in any steering mode, MPQUIC in any steering mode for uplink/downlink, ATSSS-LL in any steering mode (excluding smallest delay) for downlink, and ATSSS-LL in active-standby mode for uplink MPTCP_MPQUIC_ATSSS_LL_WITH_ASMODE_DLUL: Use MPTCP in any steering mode, MPQUIC in any steering mode for uplink/downlink, and ATSSS-LL in active-standby mode for uplink/downlink

In addition to the existing combinations, more identifiers combining MPTCP, MPQUIC-UDP, MPQUIC-IP, MPQUIC-E, and ATSSS-LL can be added. For example, combinations such as MPQUIC_UDP_ATSSS_LL (Use MPQUIC-UDP in any steering mode and ATSSS-LL in any steering mode for uplink/downlink), MPQUIC_IP_ATSSS_LL (Use MPQUIC-IP in any steering mode and ATSSS-LL in any steering mode for uplink/downlink), MPQUIC_E_ATSSS_LL (Use MPQUIC-E in any steering mode and ATSSS-LL in any steering mode for uplink/downlink), MPTCP (Use MPTCP in any steering mode for uplink/downlink), MPQUIC_UDP (Use MPQUIC-UDP in any steering mode for uplink/downlink), MPQUIC_IP (Use MPQUIC-IP in any steering mode for uplink/downlink), MPQUIC_E (Use MPQUIC-E in any steering mode for uplink/downlink), ATSSS_LL_WITH_ASMODE_DLUL (Use ATSSS-LL in active-standby mode for uplink/downlink) are possible. Identifiers signifying the above combinations may be defined as string-type identifiers and included in SBI messages.

Step 208: Request for Policy Control Rule from Session Management Function to Policy Control Function The SMF transmits Npcf_SMPolicyControl_Create Request or Npcf_SMPolicyControl_Update Request, which is a request message for creation or modification of a session policy, to the PCF. In Npcf_SMPolicyControl_Create Request or Npcf_SMPolicyControl_Update Request, accessType is the type of access proceeding with signaling for the corresponding Multi-Access Protocol Data Unit Session, and addAccessInfo is the type of another access to perform access traffic steering. maPduInd is a processing method requested for the corresponding Multi-Access Protocol Data Unit Session, and atsssCapab is an access traffic steering capability to be provided to the user terminal in steps 204 to 207, determined by the SMF. The SMF receives Npcf_SMPolicyControl_Create Response or Npcf_SMPolicyControl_Update Response including created or modified session policy information from the PCF. SmPolicyDecision included in Npcf_SMPolicyControl_Create Response or Npcf_SMPolicyControl_Update Response includes the following policy information. traffContDecs has access traffic steering processing policy information for specific traffic, and pccRules has processing policy information such as QoS for specific traffic. Among them, the steering function (steerFun) indicates the ATSSS steering functionality, and one or more identifiers signifying MPQUIC-UDP, MPQUIC-IP, and MPQUIC-E can be further defined in addition to the conventionally defined MPTCP, MPQUIC, and ATSSS_LL; these identifiers can be defined as string-type identifiers and included in SBI messages. The SMF may use a predefined policy control rule (predefined PCC rule) stored in the SMF without interworking with the PCF. Also in this case, MPQUIC-UDP, MPQUIC-IP, and MPQUIC-E can be further defined as steering functions to be applied in addition to MPTCP, MPQUIC, and ATSSS_LL.

Step 209: Selection of User Plane Function The SMF uses the ATSSS-ST received from the user terminal in step 203 and the access traffic steering functionality of the UPF when creating the access traffic steering capability of steps 204 to 207. For this, the SMF uses PFCP Association Setup Request/Response when establishing an association with the UPF. The Node ID included in PFCP Association Setup Request/Response is an identifier of the connecting SMF or UPF. UP Function Features include access traffic steering functionalities supported by the UPF. The access traffic steering functionalities supported by the UPF may further define one or more identifiers signifying MPQUIC-UDP, MPQUIC-IP, and MPQUIC-E in addition to the conventionally defined MPTCP, MPQUIC, and ATSSS_LL, and these identifiers can be applied as a mask indicating whether the corresponding protocol is supported in a bit form. The SMF selects a UPF considering the ATSSS-ST received from the user terminal, the access traffic steering functionality of the UPF, the access traffic steering capability (atsssCapa), the access traffic steering functionality included in the policy control rule, etc.

Steps 210 and 211: Establishment of Packet Forwarding Control Protocol Session The SMF transmits a PFCP Session Establishment Request or PFCP Session Modification Request for establishing or modifying a packet forwarding control protocol session to the UPF. The PFCP Session Establishment Request or PFCP Session Modification Request includes ProvideAtsssControlInformation which is request control information related to access traffic steering, and ProvideAtsssControlInformation includes the following. As MPTCP Control Information, TCI requests the use of MPTCP function for the corresponding packet forwarding control protocol session to the UPF. As ATSSS-LL Control Information, LLI requests the use of ATSSS-LL function for the corresponding packet forwarding control protocol session to the UPF. PMF Control Information requests the use of the performance measurement functionality for the corresponding packet forwarding control protocol session to the UPF. PMFI indicates application of the performance measurement functionality, DRTTI indicates exclusion of RTT measurement of the performance measurement functionality, PQPM indicates performance measurement for a specific QoS flow, Number of QFI indicates the number of candidate QFIs to measure performance, and value of QFI indicates candidate QFIs to measure performance. As MPQUIC Control Information, the conventional CUDP requests the use of MPQUIC-UDP. Besides, one or more of CIP and CE are further added and used. CIP indicates the use of MPQUIC-IP indicating that the proxy type of MPQUIC is Internet Protocol, and CE can indicate the use of MPQUIC-E indicating that the proxy type of MPQUIC is Ethernet.

Step 212: Response to Establishment of Packet Forwarding Control Protocol Session The SMF receives PFCP Session Establishment Response or PFCP Session Modification Response as a response to the packet forwarding control protocol session establishment or modification request from the UPF. The PFCP Session Establishment Response or PFCP Session Modification Response includes AtsssControlParameters which is reception control information related to access traffic steering, and AtsssControlParameters includes the following. MPTCP Parameters include MPTCP Address Information containing Internet Protocol version and Internet Protocol address and port information of the MPTCP proxy, and MPTCP Link-Specific IP Address containing Internet Protocol version and link-specific multi-path address information. ATSSS-LL Parameters indicate activation of ATSSS-LL with LLI. PMF Parameters include PMF Address Information containing Internet Protocol version used for performance measurement functionality or Ethernet status and Internet Protocol address and port information or MAC address, and QoS flow identifier indicating QFI to be used for performance measurement. MPQUIC Parameters include MPQUIC Address Information containing Internet Protocol version and Internet Protocol address and port information of the MPQUIC proxy, and MPQUIC Link-Specific IP Address containing Internet Protocol version and link-specific multi-path address information.

Similar to the conventional MPQUIC Parameters, the following two methods are possible to provide information on MPQUIC-UDP, MPQUIC-IP, and MPQUIC-E. The first method is to add one or more of MPQUIC-UDP Parameters, MPQUIC-IP Parameters, and MPQUIC-E Parameters, respectively, similar to MPQUIC Parameters. MPQUIC-UDP Address Information includes Internet Protocol version and Internet Protocol address and port information of the MPQUIC-UDP proxy, and MPQUIC-UDP Link-Specific IP Address has Internet Protocol version and link-specific multi-path address information. MPQUIC-IP Address Information includes Internet Protocol version and Internet Protocol address and port information of the MPQUIC-IP proxy, and MPQUIC-IP Link-Specific IP Address has Internet Protocol version and link-specific multi-path address information. MPQUIC-E Address Information includes Internet Protocol version and Internet Protocol address and port information of the MPQUIC-E proxy, and MPQUIC-E Link-Specific IP Address has Internet Protocol version and link-specific multi-path address information. The second method is to use MPQUIC Parameters as an array while adding an MPQUICtype field to each MPQUIC Parameters. That is, it becomes the form of Array of [MPQUIC Parameters], and MPQUICtype distinguishes whether it is MPQUIC-UDP, MPQUIC-IP, or MPQUIC-E. MPQUIC Address Information is identical to the existing MPQUIC Address Information, and MPQUIC Link-Specific IP Address is identical to the existing MPQUIC Link-Specific IP Address.

Steps 213 to 216: Response to Protocol Data Unit Session Establishment The SMF transmits PDU Session Establishment Reject, PDU Session Modification Reject, PDU Session Establishment Accept, or PDU Session Modification Command as a response to the protocol data unit session establishment or modification request from the user terminal. The SMF may use Namf_Communication_N1N2MessageTransfer to the AMF to provide the message to the user terminal. Namf_Communication_N1N2MessageTransfer can inform the UE by the AMF using the maAcceptedInd information element to indicate with 1 bit whether the corresponding Multi-Access Protocol Data Unit Session has been accepted as a Multi-Access Protocol Data Unit Session or as a Single-Access Protocol Data Unit Session. Namf_Communication_N1N2MessageTransfer can further indicate whether the corresponding Single-Access Protocol Data Unit Session is 3GPP access or Non-3GPP access using the targetAccess information element.

PDU Session Establishment Reject, PDU Session Modification Reject, PDU Session Establishment Accept, or PDU Session Modification Command may include the following. PDU session ID is an identifier of the corresponding Multi-Access Protocol Data Unit Session. 5GSM cause is a reason for PDU Session Establishment Reject or PDU Session Modification Reject, and may indicate that the steering functionality requested by the corresponding user terminal is not supported. ATSSS-ST included in ATSSS PCO of Extended PCO provides the access traffic steering protocol configuration configured by the SMF. ATSSS container has ATSSS parameters including the following. ATSSS rules are provided to the user terminal by the SMF and are generated by the SMF from policy control rules. MPTCP network steering functionalities information matches each information item in MPTCP Parameters received by the SMF in step 212. Measurement assistance information matches each information item in PMF Control Information received by the SMF in step 212. MPQUIC network steering functionalities information matches each information item in MPQUIC Parameters received by the SMF in step 212.

The Steering functionality of Access selection descriptor included in ATSSS rules can define one or more identifiers signifying MPQUIC-UDP functionality, MPQUIC-IP functionality, and MPQUIC-E functionality in addition to the conventionally defined 1: UE's supported steering functionality, 2: MPTCP functionality, 3: ATSSS-LL functionality, 4: MPQUIC functionality, and these identifiers can be included in the NAS message as numeric identifiers. Measurement assistance information may have MAC address, Internet Protocol address and port depending on the protocol data unit session type. One or more of MPQUIC-UDP network steering functionalities information, MPQUIC-IP network steering functionalities information, and MPQUIC-E network steering functionalities information can be further added in addition to the existing MPQUIC network steering functionalities information, and at this time, Proxy type can define one or more identifiers signifying MPQUIC-IP and MPQUIC-E in addition to the existing 1: MPTCP, 2: MPQUIC-UDP, and these identifiers can be numeric identifiers.

The SMF may provide Measurement assistance information to the user terminal as ATSSS parameters in the following cases. When receiving any steering mode as ATSSS-LL function as access traffic steering capability or access traffic steering protocol configuration option from the user terminal, and the SMF accepts the received access traffic steering function. The access traffic steering capability or access traffic steering protocol configuration option indicates ATSSS capability (Access Traffic Steering, Switching, Splitting capability) of the user terminal (UE) or Supported ATSSS steering functionalities and steering modes supported by the user terminal. Also, when receiving any one of various combinations such as a combination supporting any steering mode as MPTCP function and only active-standby steering mode as ATSSS-LL function, a combination supporting any steering mode as MPQUIC-UDP function and only active-standby steering mode as ATSSS-LL function, a combination supporting any steering mode as MPQUIC-IP function and only active-standby steering mode as ATSSS-LL function, a combination supporting any steering mode as MPQUIC-E function and only active-standby steering mode as ATSSS-LL function from the user terminal as access traffic steering capability or access traffic steering protocol configuration option, and the SMF accepts the received access traffic steering functions as they are. Also, when receiving any one of various combinations similar to the above from the user terminal as access traffic steering capability or access traffic steering protocol configuration option, and the SMF accepts only any steering mode as ATSSS-LL function or only active-standby steering mode as ATSSS-LL function.

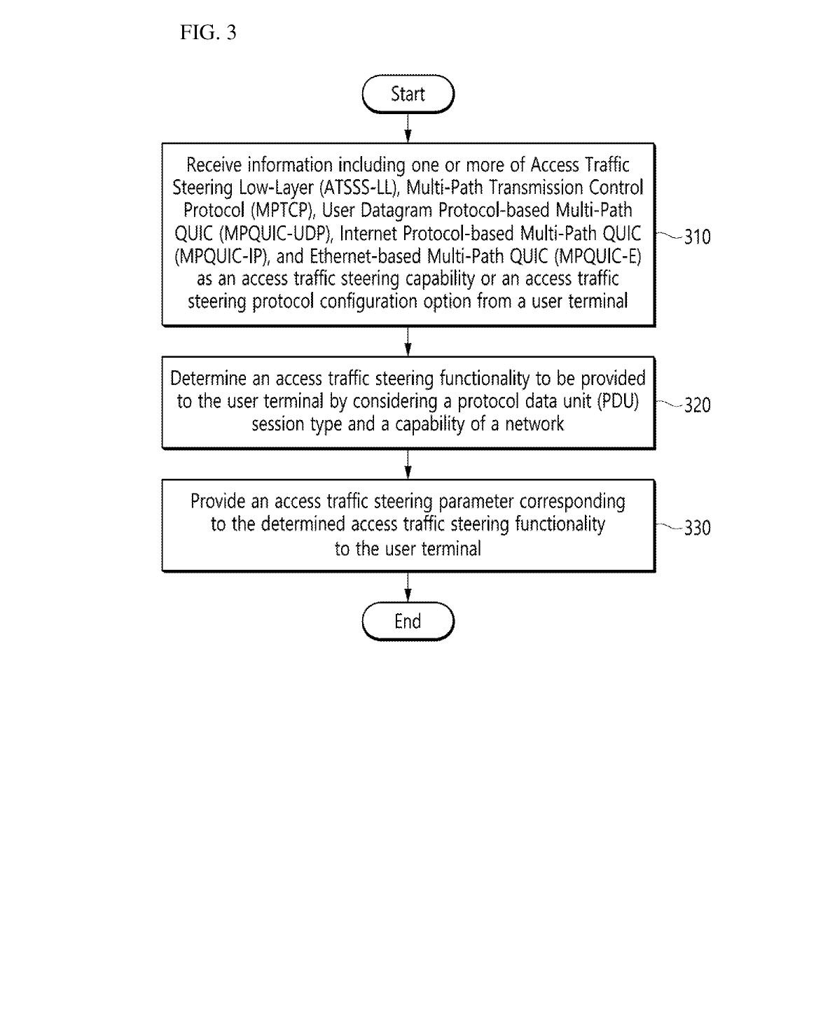

FIG. 3 is a flowchart illustrating an operating method of a session management function according to an embodiment of the present disclosure. Referring to FIG. 3, in step 310, the SMF receives access traffic steering capability information or access traffic steering protocol configuration option from the user terminal. The access traffic steering capability information may be composed of a combination including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E). In one embodiment, the SMF may receive a Protocol Data Unit Session Establishment Request (PDU Session Establishment Request) or Protocol Data Unit Session Modification Request (PDU Session Modification Request) from the user terminal through the Access and Mobility Management Function (AMF). The request message may include Access Traffic Steering Steering Function (ATSSS-ST) information included in 5GSM capability or access traffic steering steering function information included in Access Traffic Steering Protocol Configuration Option (ATSSS PCO) of Extended Protocol Configuration Option (Extended PCO). The access traffic steering steering function information provided by the user terminal may additionally include the following combinations in addition to the conventionally defined combinations. For example, a combination using MPQUIC-UDP in any steering mode and ATSSS-LL in active-standby mode, a combination using MPQUIC-UDP in any steering mode and ATSSS-LL in any steering mode, a combination using MPTCP in any steering mode and MPQUIC-UDP in any steering mode and ATSSS-LL in active-standby mode, a combination using MPTCP in any steering mode and MPQUIC-UDP in any steering mode and ATSSS-LL in any steering mode, etc. are possible. Also, a combination using MPQUIC-IP in any steering mode and ATSSS-LL in active-standby mode, a combination using MPQUIC-IP in any steering mode and ATSSS-LL in any steering mode, a combination using MPTCP in any steering mode and MPQUIC-IP in any steering mode and ATSSS-LL in active-standby mode, a combination using MPTCP in any steering mode and MPQUIC-IP in any steering mode and ATSSS-LL in any steering mode are possible. Also, a combination using MPQUIC-UDP in any steering mode and MPQUIC-IP in any steering mode and ATSSS-LL in active-standby mode, a combination using MPQUIC-UDP in any steering mode and MPQUIC-IP in any steering mode and ATSSS-LL in any steering mode are possible. Also, a combination using MPTCP in any steering mode and MPQUIC-UDP in any steering mode and MPQUIC-IP in any steering mode and ATSSS-LL in active-standby mode, a combination using MPTCP in any steering mode and MPQUIC-UDP in any steering mode and MPQUIC-IP in any steering mode and ATSSS-LL in any steering mode are possible. Also, a combination using MPTCP in any steering mode, a combination using MPQUIC-UDP in any steering mode, a combination using MPQUIC-IP in any steering mode, a combination using MPQUIC-E in any steering mode, and a combination using ATSSS-LL in active-standby mode are possible. Also, a combination using MPQUIC-E in any steering mode and ATSSS-LL in active-standby mode, and a combination using MPQUIC-E in any steering mode and ATSSS-LL in any steering mode are possible.

In step 320, the SMF determines an access traffic steering function to be provided to the user terminal considering at least one of the protocol data unit session type, a User Equipment (UE) capability and the capability of the network. In one embodiment, the SMF can check the protocol data unit session type (PDU session type) received from the user terminal. The protocol data unit session type may be one of IPv4, IPv6, IPv4v6, Unstructured, or Ethernet. In one embodiment, the SMF can check the access traffic steering function of the User Plane Function (UPF) that will support the corresponding protocol data unit session as the network capability. The SMF can check the access traffic steering function supported by the UPF through UP Function Features during the Packet Forwarding Control Protocol (PFCP) Association Setup process with the UPF. The UP Function Features may indicate support of Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) in addition to conventionally defined MPTCP, MPQUIC, and ATSSS-LL in a bit form.

In one embodiment, the SMF may receive a Policy Control Rule (PCC rule) from the Policy Control Function (PCF). The SMF transmits a Session Policy Creation or Modification Request (Npcf_SMPolicyControl_Create Request or Npcf_SMPolicyControl_Update Request) to the PCF, and may receive a response (Npcf_SMPolicyControl_Create Response or Npcf_SMPolicyControl_Update Response) including Session Policy Decision (SmPolicyDecision) from the PCF. The steering function (steerFun) included in the session policy decision indicates an access traffic steering function to be applied to specific traffic, and may include MPQUIC-UDP, MPQUIC-IP, and MPQUIC-E in addition to conventionally defined MPTCP, MPQUIC, and ATSSS_LL. In one embodiment, the SMF may use a predefined policy control rule (predefined PCC rule) stored in the SMF without interworking with the PCF. Even in this case, the steering function to be applied may include MPQUIC-UDP, MPQUIC-IP, and MPQUIC-E in addition to existing MPTCP, MPQUIC, and ATSSS_LL.

In one embodiment, the SMF may determine an intersection by comparing the access traffic steering steering function information received from the user terminal with the access traffic steering function of the UPF. If no intersection exists, the SMF may accept the corresponding Multi-Access Protocol Data Unit Session establishment request as a Single-Access PDU Session establishment rather than a Multi-Access Protocol Data Unit Session, or reject the corresponding Multi-Access Protocol Data Unit Session establishment request.

In one embodiment, the SMF may selectively determine the access traffic steering capability (atsssCapa) according to the protocol data unit session type. When the protocol data unit session type is an Internet Protocol type (one of IPv4, IPv6, or IPv4v6), the SMF may select a combination including one or more of MPTCP, MPQUIC-UDP, and MPQUIC-IP. On the other hand, when the protocol data unit session type is an Ethernet type, the SMF may select a combination including MPQUIC-E.

When the protocol data unit session type is an Internet Protocol type (one of IPv4, IPv6, or IPv4v6), the SMF may select a combination including at least one of ATSSS-LL, MPTCP, MPQUIC-UDP, or MPQUIC-IP. On the other hand, when the protocol data unit session type is an Ethernet type, the SMF may select a combination including at least one of ATSSS-LL or MPQUIC-E.

This is to ensure the consistency of the protocol stack. In one embodiment, the access traffic steering capability (atsssCapa) determined by the SMF may include additional combinations besides the conventionally defined combinations. For example, MPQUIC_UDP_ATSSS_LL (Use MPQUIC-UDP in any steering mode and ATSSS-LL in any steering mode for uplink/downlink), MPQUIC_UDP_ATSSS_LL_WITH_ASMODE_UL (Use MPQUIC-UDP in any steering mode for uplink/downlink, ATSSS-LL in any steering mode for downlink, and ATSSS-LL in active-standby mode for uplink), MPQUIC_UDP_ATSSS_LL_WITH_EXSDMODE_DL_ASMODE_UL (Use MPQUIC-UDP in any steering mode for uplink/downlink, ATSSS-LL in any steering mode (excluding smallest delay) for downlink, and ATSSS-LL in active-standby mode for uplink), MPQUIC_UDP_ATSSS_LL_WITH_ASMODE_DLUL (Use MPQUIC-UDP in any steering mode for uplink/downlink and ATSSS-LL in active-standby mode for uplink/downlink), etc. are possible. Also, combinations such as MPQUIC_IP_ATSSS_LL (Use MPQUIC-IP in any steering mode and ATSSS-LL in any steering mode for uplink/downlink), MPQUIC_IP_ATSSS_LL_WITH_ASMODE_UL, MPQUIC_IP_ATSSS_LL_WITH_EXSDMODE_DL_ASMODE_UL, MPQUIC_IP_ATSSS_LL_WITH_ASMODE_DLUL are possible. Also, combinations such as MPTCP_MPQUIC_UDP_ATSSS_LL, MPTCP_MPQUIC_UDP_ATSSS_LL_WITH_ASMODE_UL, MPTCP_MPQUIC_UDP_ATSSS_LL_WITH_EXSDMODE_DL_ASMODE_UL, MPTCP_MPQUIC_UDP_ATSSS_LL_WITH_ASMODE_DLUL are possible. Also, combinations such as MPTCP_MPQUIC_IP_ATSSS_LL, MPTCP_MPQUIC_IP_ATSSS_LL_WITH_ASMODE_UL, MPTCP_MPQUIC_IP_ATSSS_LL_WITH_EXSDMODE_DL_ASMODE_UL, MPTCP_MPQUIC_IP_ATSSS_LL_WITH_ASMODE_DLUL are possible. Also, combinations such as MPQUIC_UDP_MPQUIC_IP_ATSSS_LL, MPQUIC_UDP_MPQUIC_IP_ATSSS_LL_WITH_ASMODE_UL, MPQUIC_UDP_MPQUIC_IP_ATSSS_LL_WITH_EXSDMODE_DL_ASMODE_UL, MPQUIC_UDP_MPQUIC_IP_ATSSS_LL_WITH_ASMODE_DLUL are possible. Also, combinations such as MPTCP_MPQUIC_UDP_MPQUIC_IP_ATSSS_LL, MPTCP_MPQUIC_UDP_MPQUIC_IP_ATSSS_LL_WITH_ASMODE_UL, MPTCP_MPQUIC_UDP_MPQUIC_IP_ATSSS_LL_WITH_EXSDMODE_DL_ASMODE_UL, MPTCP_MPQUIC_UDP_MPQUIC_IP_ATSSS_LL_WITH_ASMODE_DLUL are possible. Also, combinations such as MPQUIC_E_ATSSS_LL, MPQUIC_E_ATSSS_LL_WITH_ASMODE_UL, MPQUIC_E_ATSSS_LL_WITH_EXSDMODE_DL_ASMODE_UL, MPQUIC_E_ATSSS_LL_WITH_ASMODE_DLUL are possible. Also, combinations such as MPTCP (Use MPTCP in any steering mode for uplink/downlink), MPQUIC_UDP (Use MPQUIC-UDP in any steering mode for uplink/downlink), MPQUIC_IP (Use MPQUIC-IP in any steering mode for uplink/downlink), MPQUIC_E (Use MPQUIC-E in any steering mode for uplink/downlink), ATSSS_LL_WITH_ASMODE_DLUL (Use ATSSS-LL in active-standby mode for uplink/downlink) are possible.

In one embodiment, the SMF may transmit a Packet Forwarding Control Protocol Session Establishment Request (PFCP Session Establishment Request) or Packet Forwarding Control Protocol Session Modification Request (PFCP Session Modification Request) to the UPF. The request message includes ProvideAtsssControlInformation, which may include one or more of MPTCP Control Information, ATSSS-LL Control Information, PMF Control Information, and MPQUIC Control Information. In one embodiment, MPQUIC Control Information may further include one or more of CIP (Connect-IP) and CE (Connect-Ethernet) in addition to existing CUDP (Connect-UDP). CUDP indicates requesting the use of MPQUIC-UDP, CIP indicates requesting the use of MPQUIC-IP, and CE indicates requesting the use of MPQUIC-E. One or more of CUDP, CIP, and CE can be configured simultaneously. In one embodiment, the SMF may receive a PFCP Session Establishment Response or PFCP Session Modification Response from the UPF. The response message includes AtsssControlParameters, which may include one or more of MPTCP Parameters, ATSSS-LL Parameters, PMF Parameters, and MPQUIC Parameters. In one embodiment, one of the following two methods may be used to provide information on MPQUIC-UDP, MPQUIC-IP, and MPQUIC-E similar to the conventional MPQUIC Parameters. The first method is to add one or more of MPQUIC-UDP Parameters, MPQUIC-IP Parameters, and MPQUIC-E Parameters, respectively, similar to MPQUIC Parameters. MPQUIC-UDP Address Information includes Internet Protocol version and Internet Protocol address and port information of the MPQUIC-UDP proxy, and MPQUIC-UDP Link-Specific IP Address has Internet Protocol version and link-specific multi-path address information. MPQUIC-IP Address Information includes Internet Protocol version and Internet Protocol address and port information of the MPQUIC-IP proxy, and MPQUIC-IP Link-Specific IP Address has Internet Protocol version and link-specific multi-path address information. MPQUIC-E Address Information includes Internet Protocol version and Internet Protocol address and port information of the MPQUIC-E proxy, and MPQUIC-E Link-Specific IP Address has Internet Protocol version and link-specific multi-path address information. The second method is to use MPQUIC Parameters as an array while adding an MPQUICtype field to each MPQUIC Parameters. That is, it becomes the form of Array of [MPQUIC Parameters], and MPQUICtype distinguishes whether it is MPQUIC-UDP, MPQUIC-IP, or MPQUIC-E. MPQUIC Address Information is identical to the existing MPQUIC Address Information, and MPQUIC Link-Specific IP Address is identical to the existing MPQUIC Link-Specific IP Address.

In step 330, the SMF provides an access traffic steering parameter corresponding to the determined access traffic steering function to the user terminal. The access traffic steering parameter may be Network steering functionalities information determined by the network. The access traffic steering parameter may include a Client IP address and proxy information. The Client IP address may include a Client 3GPP IP address and a Client Non-3GPP IP address. In one embodiment, the SMF may transmit one of PDU Session Establishment Reject, PDU Session Modification Reject, PDU Session Establishment Accept, or PDU Session Modification Command to the user terminal. In one embodiment, the SMF may transfer the message to the user terminal using Namf_Communication_N1N2MessageTransfer to the AMF. Namf_Communication_N1N2MessageTransfer may inform the AMF by using the maAcceptedInd information element to indicate with 1 bit whether the corresponding Multi-Access Protocol Data Unit Session has been accepted as a Multi-Access Protocol Data Unit Session or as a Single-Access Protocol Data Unit Session. Namf_Communication_N1N2MessageTransfer may further indicate whether the corresponding Single-Access Protocol Data Unit Session is 3GPP access or Non-3GPP access using the targetAccess information element. In one embodiment, the PDU Session Establishment Reject or PDU Session Modification Reject message may include a 5GSM cause, which may indicate that the steering function requested by the corresponding user terminal is not supported. In one embodiment, the PDU Session Establishment Accept or PDU Session Modification Command message may include the ATSSS-ST included in ATSSS PCO of Extended PCO, which provides the access traffic steering protocol configuration configured by the SMF. In one embodiment, the PDU Session Establishment Accept or PDU Session Modification Command message may include an ATSSS container, which has ATSSS parameters. The ATSSS parameters may include one or more of ATSSS rules, MPTCP network steering functionalities information, Measurement assistance information, and MPQUIC network steering functionalities information. In one embodiment, ATSSS rules are provided to the user terminal by the SMF and are generated by the SMF from policy control rules. The Steering functionality of Access selection descriptor included in ATSSS rules can define one or more identifiers signifying MPQUIC-UDP functionality, MPQUIC-IP functionality, and MPQUIC-E functionality in addition to the conventionally defined 1: UE's supported steering functionality, 2: MPTCP functionality, 3: ATSSS-LL functionality, 4: MPQUIC functionality, and these identifiers can be included in the NAS message as numeric identifiers. In one embodiment, MPTCP network steering functionalities information is generated by matching each information item in MPTCP Parameters received by the SMF from the UPF. In one embodiment, Measurement assistance information is generated by matching each information item in PMF Control Information received by the SMF from the UPF. Measurement assistance information may have MAC address, Internet Protocol address and port depending on the protocol data unit session type. Specifically, for an Ethernet protocol data unit session, a 3GPP MAC address and a Non-3GPP MAC address are provided respectively, and for an Internet protocol protocol data unit session, a 3GPP Internet protocol address, a Non-3GPP Internet protocol address, a 3GPP port, and a Non-3GPP port are provided respectively. In one embodiment, the SMF may provide Measurement assistance information to the user terminal as ATSSS parameters in the following cases. First, when receiving any steering mode as ATSSS-LL function as access traffic steering capability or access traffic steering protocol configuration option from the user terminal, and the SMF accepts the received access traffic steering function. Second, when receiving any one of various combinations such as a combination supporting any steering mode as MPTCP function and only active-standby steering mode as ATSSS-LL function, a combination supporting any steering mode as MPQUIC-UDP function and only active-standby steering mode as ATSSS-LL function, a combination supporting any steering mode as MPQUIC-IP function and only active-standby steering mode as ATSSS-LL function, a combination supporting any steering mode as MPQUIC-E function and only active-standby steering mode as ATSSS-LL function from the user terminal as access traffic steering capability or access traffic steering protocol configuration option, and the SMF accepts the received access traffic steering functions as they are. Third, when receiving any one of various combinations similar to the above from the user terminal as access traffic steering capability or access traffic steering protocol configuration option, and the SMF accepts only any steering mode as ATSSS-LL function or only active-standby steering mode as ATSSS-LL function.

In one embodiment, MPQUIC network steering functionalities information is generated by matching each information item in MPQUIC Parameters received by the SMF from the UPF. In one embodiment, one or more of MPQUIC-UDP network steering functionalities information, MPQUIC-IP network steering functionalities information, and MPQUIC-E network steering functionalities information can be further added in addition to the existing MPQUIC network steering functionalities information. At this time, Proxy type can define one or more identifiers signifying MPQUIC-IP and MPQUIC-E in addition to the existing 1: MPTCP, 2: MPQUIC-UDP, and these identifiers can be numeric identifiers. In one embodiment, each of MPQUIC-UDP network steering functionalities information, MPQUIC-IP network steering functionalities information, and MPQUIC-E network steering functionalities information may include Client 3GPP IP address type, Client 3GPP IP address, Client Non-3GPP IP address type, Client Non-3GPP IP address, and Proxy information. Proxy information may include one or more of Proxy IP address type, Proxy IP address, Proxy port, and Proxy type. One or more pieces of Proxy information including Proxy IP address type, Proxy IP address, Proxy port, or Proxy type may be provided to indicate multiple proxy servers. The multiple proxy servers may be of different proxy types. The address type of the multiple proxy servers may be any one of IPv4, IPv6, or IPv4v6. The Proxy IP address may have one or more IP addresses. According to an embodiment, it may have one or more IPv4 addresses, or one or more IPv6 addresses, or one or more IPv4 addresses and one or more IPv6 addresses. The Proxy port may have one or more port numbers of the corresponding proxy server. According to an embodiment, it may have one port number per address of the proxy server. The Proxy type may be any one of MPTCP proxy, UDP proxy, IP proxy, and Ethernet proxy. The MPTCP proxy can be used for MPTCP, the UDP proxy can be used for MPQUIC-UDP, and the IP proxy can be used for MPQUIC-IP. The Ethernet proxy can be used for MPQUIC-E. According to an embodiment, the proxy type can be represented as 1 for MPTCP proxy, 2 for UDP proxy, 3 for IP proxy, and 4 for Ethernet proxy. The Client 3GPP IP address type may be any one of IPv4, IPv6, or IPv4v6. The Client 3GPP IP address may also have one or more IP addresses. As an embodiment, it may have one or more IPv4 addresses, or one or more IPv6 addresses, or one or more IPv4 addresses and one or more IPv6 addresses according to the Client 3GPP IP address type. The Client Non-3GPP IP address type may also have one of IPv4, IPv6, or IPv4v6, and the Client Non-3GPP IP address may also have one or more IP addresses. According to an embodiment, it may have one or more IPv4 addresses, or one or more IPv6 addresses, or one or more IPv4 addresses and one or more IPv6 addresses according to the Client Non-3GPP IP address type.

As described above, the operating method of the SMF according to an embodiment of the present disclosure receives access traffic steering capability information including various MPQUIC protocol combinations from the user terminal, determines an appropriate access traffic steering function considering the protocol data unit session type and network capability, and provides the determined access traffic steering parameter to the user terminal, thereby enabling optimized multi-access traffic processing even in a congested frequency environment.

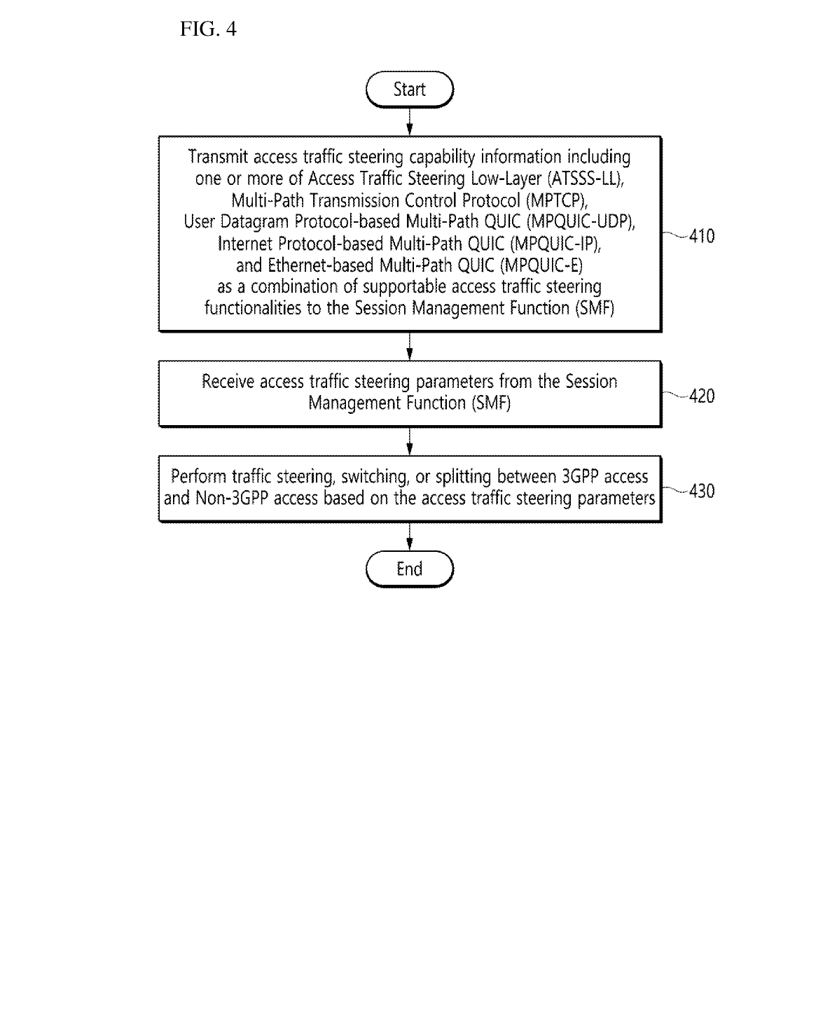

FIG. 4 is a flowchart illustrating an operating method of a user terminal according to an embodiment of the present disclosure. Referring to FIG. 4, in step 410, the user terminal transmits access traffic steering capability information to the SMF. The access traffic steering capability information may be composed of a combination including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as a combination of supportable access traffic steering functions. In one embodiment, the user terminal may transmit a PDU Session Establishment Request or PDU Session Modification Request to the SMF through the AMF. The request message may include Access Traffic Steering Steering Function (ATSSS-ST) information included in 5GSM capability or access traffic steering steering function information included in Access Traffic Steering Protocol Configuration Option (ATSSS PCO) of Extended Protocol Configuration Option (Extended PCO). In one embodiment, the access traffic steering steering function information provided by the user terminal may additionally include the following combinations in addition to the conventionally defined combinations. For example, a combination using MPQUIC-UDP in any steering mode and ATSSS-LL in active-standby mode, a combination using MPQUIC-UDP in any steering mode and ATSSS-LL in any steering mode, a combination using MPTCP in any steering mode and MPQUIC-UDP in any steering mode and ATSSS-LL in active-standby mode, a combination using MPTCP in any steering mode and MPQUIC-UDP in any steering mode and ATSSS-LL in any steering mode, etc. are possible. Also, a combination using MPQUIC-IP in any steering mode and ATSSS-LL in active-standby mode, a combination using MPQUIC-IP in any steering mode and ATSSS-LL in any steering mode, a combination using MPTCP in any steering mode and MPQUIC-IP in any steering mode and ATSSS-LL in active-standby mode, a combination using MPTCP in any steering mode and MPQUIC-IP in any steering mode and ATSSS-LL in any steering mode are possible. Also, a combination using MPQUIC-UDP in any steering mode and MPQUIC-IP in any steering mode and ATSSS-LL in active-standby mode, a combination using MPQUIC-UDP in any steering mode and MPQUIC-IP in any steering mode and ATSSS-LL in any steering mode are possible. Also, a combination using MPTCP in any steering mode and MPQUIC-UDP in any steering mode and MPQUIC-IP in any steering mode and ATSSS-LL in active-standby mode, a combination using MPTCP in any steering mode and MPQUIC-UDP in any steering mode and MPQUIC-IP in any steering mode and ATSSS-LL in any steering mode are possible. Also, a combination using MPTCP in any steering mode, a combination using MPQUIC-UDP in any steering mode, a combination using MPQUIC-IP in any steering mode, a combination using MPQUIC-E in any steering mode, and a combination using ATSSS-LL in active-standby mode are possible. Also, a combination using MPQUIC-E in any steering mode and ATSSS-LL in active-standby mode, and a combination using MPQUIC-E in any steering mode and ATSSS-LL in any steering mode are possible.

In one embodiment, the user terminal may provide the Protocol Data Unit Session Type (PDU session type) together. The protocol data unit session type may be one of IPv4, IPv6, IPv4v6, Unstructured, or Ethernet. When the protocol data unit session type is one of IPv4, IPv6, or IPv4v6, the user terminal may provide a combination including one or more of MPTCP, MPQUIC-UDP, and MPQUIC-IP. On the other hand, when the protocol data unit session type is Ethernet, the user terminal may provide a combination including MPQUIC-E.

In step 420, the user terminal receives an access traffic steering parameter from the SMF. The access traffic steering parameter is a parameter corresponding to the access traffic steering function determined by the SMF considering the protocol data unit session type and the network capability. In one embodiment, the user terminal may receive the access traffic steering parameter through a PDU Session Establishment Accept or PDU Session Modification Command message. In one embodiment, the access traffic steering parameter may be included in an ATSSS container, which may include one or more of ATSSS rules, MPTCP network steering functionalities information, Measurement assistance information, and MPQUIC network steering functionalities information. In one embodiment, the Steering functionality of Access selection descriptor included in ATSSS rules may include MPQUIC-UDP functionality, MPQUIC-IP functionality, and MPQUIC-E functionality in addition to the conventionally defined 1: UE's supported steering functionality, 2: MPTCP functionality, 3: ATSSS-LL functionality, 4: MPQUIC functionality. These identifiers can be included in the NAS message as numeric identifiers. In one embodiment, the access traffic steering parameter may include one or more of MPQUIC-UDP network steering functionalities information, MPQUIC-IP network steering functionalities information, and MPQUIC-E network steering functionalities information. In one embodiment, each of the MPQUIC-UDP network steering functionalities information, MPQUIC-IP network steering functionalities information, and MPQUIC-E network steering functionalities information may include Client 3GPP IP address type, Client 3GPP IP address, Client Non-3GPP IP address type, Client Non-3GPP IP address, and Proxy information. The Proxy information may include one or more of Proxy IP address type, Proxy IP address, Proxy port, or Proxy type. The Proxy type may include MPQUIC-IP and MPQUIC-E in addition to the existing 1: MPTCP, 2: MPQUIC-UDP.

In one embodiment, the access traffic steering parameter may include Measurement assistance information. The Measurement assistance information is information informing the PMF on the user terminal side of the address, port, etc., of the UPF side PMF. For an Ethernet protocol data unit session, a 3GPP MAC address and a Non-3GPP MAC address are provided respectively, and for an Internet protocol protocol data unit session, a 3GPP Internet protocol address, a Non-3GPP Internet protocol address, a 3GPP port, and a Non-3GPP port are provided respectively. The Internet protocol address provides one or more of IPv4 or IPv6 addresses according to the Internet protocol version of the protocol data unit session.

In step 430, the user terminal performs traffic steering, switching, or splitting between 3GPP access and Non-3GPP access based on the access traffic steering parameter. In one embodiment, the user terminal may perform traffic processing by applying any one of MPTCP, MPQUIC-UDP, MPQUIC-IP, MPQUIC-E, and ATSSS-LL according to the Steering functionality included in the ATSSS rules. In one embodiment, the user terminal may perform traffic processing in one of Active-Standby, Smallest Delay, Load-Balancing, Priority-based, and Redundant modes according to the Steering mode included in the ATSSS rules. In one embodiment, when the user terminal uses MPQUIC-UDP, MPQUIC-IP, or MPQUIC-E, the user terminal may establish a connection with a proxy server using the corresponding MPQUIC network steering functionalities information included in the access traffic steering parameter, and perform multi-path communication using link-specific Internet Protocol addresses for 3GPP access and Non-3GPP access. In one embodiment, when the user terminal uses ATSSS-LL, the user terminal may perform performance measurement with the UPF using the PMF address information included in the Measurement assistance information. The user terminal may measure Round-Trip Time (RTT), Packet Loss Rate (PLR), and Access Availability/Unavailability, and perform an operation according to the steering mode based on this.

As described above, the operating method of the user terminal according to an embodiment of the present disclosure provides access traffic steering capability information including various MPQUIC protocol combinations to the SMF, and performs traffic steering, switching, or splitting between 3GPP access and Non-3GPP access based on the access traffic steering parameter received from the SMF, thereby enabling optimized multi-access traffic processing according to the protocol data unit session type.

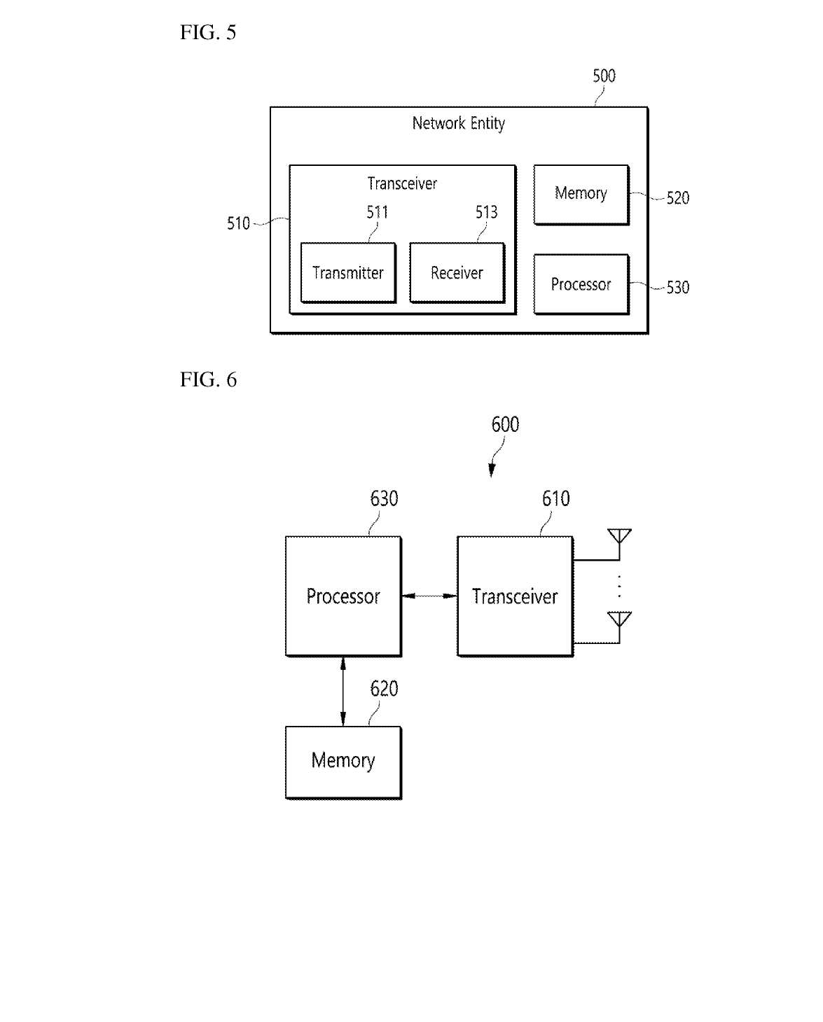

FIG. 5 is a block diagram illustrating a configuration of a session management function according to an embodiment of the present disclosure. A network entity of the present disclosure is a concept including a network function according to system implementation. Terms such as '~unit', '~er', etc. used below mean a unit that processes at least one function or operation, which may be implemented as hardware or software, or a combination of hardware and software. Referring to FIG. 5, a network entity 500 according to an embodiment of the present disclosure may include a transceiver 510, a memory 520, and a processor 530. The transceiver 510 transmits and receives signals with other network entities. The transceiver 510 may include a transmitter 511 and a receiver 513, which may be collectively referred to as a transceiver. The transceiver 510 may transmit and receive signals with a User Equipment (UE), Radio Access Network (RAN), Access and Mobility Management Function (AMF), Session Management Function (SMF), Policy Control Function (PCF), User Plane Function (UPF), Unified Data Management (UDM), etc. The memory 520 stores data such as basic programs, application programs, and configuration information for the operation of the network entity 500. The memory 520 may be composed of volatile memory, non-volatile memory, or a combination of volatile memory and non-volatile memory. And, the memory 520 provides stored data according to the request of the processor 530. In one embodiment, the memory 520 may store program codes for supporting multiple multi-path QUIC protocols. The memory 520 may store configuration information related to ATSSS steering functionality, policy control rules (PCC rules), capability information of the user terminal, characteristic information of the user plane function, etc. The processor 530 controls the overall operations of the network entity 500. For example, the processor 530 transmits and receives signals through the transceiver 510. Also, the processor 530 records and reads data in the memory 520. And, the processor 530 can perform functions of the protocol stack required by the communication standard. To this end, the processor 530 may include a circuit, an application-specific circuit, at least one processor or microprocessor, or may be part of a processor. The processor 530 may control the network entity 500 to perform any one of the operations of various embodiments of the present disclosure. Specifically, when the network entity 500 is a Session Management Function (SMF), the processor 530 may control to perform the operating method of the SMF shown in FIG. 3.

In one embodiment, the processor 530 may control to receive information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as an access traffic steering capability or an access traffic steering protocol configuration option from a user terminal. In one embodiment, the processor 530 may control to determine an access traffic steering function to be provided to the user terminal considering at least one of the protocol data unit session type, a User Equipment (UE) capability and the network capability. The processor 530 may check the PDU session type received from the user terminal, check the access traffic steering function of the UPF to support the corresponding PDU session, and determine the access traffic steering capability (atsssCapa) by receiving a PCC rule from the PCF or using a predefined PCC rule.

In one embodiment, if the protocol data unit session type is one of IPv4, IPv6, or IPv4v6, the processor 530 may control to select a combination including one or more of MPTCP, MPQUIC-UDP, and MPQUIC-IP. If the above classification is stipulated as a configuration rule, it is as follows. (i) Apply MPQUIC-UDP or MPQUIC-IP to IP type PDU session. (ii) Apply MPQUIC-E to Ethernet type PDU session. This rule embodies the purpose of ensuring consistency of the protocol stack described in 'Advantageous Effects', and applies consistently throughout this embodiment. On the other hand, if the protocol data unit session type is Ethernet, the processor 530 may control to select a combination including MPQUIC-E.

In one embodiment, if the protocol data unit session type is one of IPv4, IPv6, or IPv4v6, the processor 530 may control to select a combination including at least one of ATSSS-LL, MPTCP, MPQUIC-UDP, or MPQUIC-IP. ... On the other hand, if the protocol data unit session type is Ethernet, the processor 530 may control to select a combination including at least one of ATSSS-LL or MPQUIC-E.

In one embodiment, the processor 530 may control to transmit a Packet Forwarding Control Protocol Session Establishment Request (PFCP Session Establishment Request) or Packet Forwarding Control Protocol Session Modification Request (PFCP Session Modification Request) to the user plane function. In this embodiment, bits corresponding to the function among CUDP (CONNECT-UDP), CIP (CONNECT-IP), and CE (CONNECT-Ethernet) are set in MPQUIC Control Information, which is used identically to the nomenclature presented in the provisional application. The request message includes ProvideAtsssControlInformation, which may include one or more of MPTCP Control Information, ATSSS-LL Control Information, PMF Control Information, and MPQUIC Control Information. In one embodiment, the processor 530 may control MPQUIC Control Information to include one or more of CIP (Connect-IP) and CE (Connect-Ethernet) in addition to existing CUDP (Connect-UDP). Also, CE cannot be configured simultaneously with CUDP, and CE cannot be configured simultaneously with CIP. Accordingly, when MPQUIC-E is requested, only CE is configured, and when MPQUIC-UDP or MPQUIC-IP is requested, a combination of CUDP and/or CIP can be configured. CUDP indicates requesting the use of MPQUIC-UDP, CIP indicates requesting the use of MPQUIC-IP, and CE indicates requesting the use of MPQUIC-E.

In one embodiment, the processor 530 may control to receive a Packet Forwarding Control Protocol Session Establishment Response (PFCP Session Establishment Response) or Packet Forwarding Control Protocol Session Modification Response (PFCP Session Modification Response) from the user plane function. The response message includes AtsssControlParameters, which may include one or more of MPTCP Parameters, ATSSS-LL Parameters, PMF Parameters, and MPQUIC Parameters. In this embodiment, the value of the Proxy type item is interpreted as follows: 1: MPTCP proxy, 2: UDP proxy for MPQUIC-UDP, 3: IP proxy for MPQUIC-IP, 4: Ethernet Proxy for MPQUIC-E. This value is commonly applied to 'MPQUIC(-UDP/-IP/-E) network steering functionalities information' and is set in conjunction with the Access selection/Steering function of ATSSS parameters.

In one embodiment, the processor 530 may control to provide an access traffic steering parameter corresponding to the determined access traffic steering function to the user terminal. The processor 530 may control to transmit a PDU Session Establishment Accept or PDU Session Modification Command to the user terminal, and the message may include an ATSSS container. Also, Measurement Assistance Information (MAI)/PMF Parameters include the following items depending on the PDU session type. • IP PDU Session: PMF IPv4/IPv6 Address(V4/V6), 3GPP/Non-3GPP Port, Link-Specific IP Address (3GPP/Non-3GPP) if necessary • Ethernet PDU Session: 3GPP/Non-3GPP MAC Address, Link-Specific IP Address (3GPP/Non-3GPP) if necessary The item configuration follows the field system of PMF Address Information/MPQUIC Address Information and MAI description.

In one embodiment, the processor 530 may control the access traffic steering parameter to include one or more of MPQUIC-UDP network steering functionalities information, MPQUIC-IP network steering functionalities information, and MPQUIC-E network steering functionalities information. In one embodiment, the processor 530 may control the Steering functionality of Access selection descriptor included in ATSSS rules to include one or more of MPQUIC-UDP functionality, MPQUIC-IP functionality, and MPQUIC-E functionality. The transceiver 510 and the processor 530 do not necessarily have to be implemented as separate modules, and of course, can be implemented as a single component in the form of a single chip or software block. The transceiver 510, memory 520, and processor 530 may be electrically connected. The network entity 500 includes a network node, and may be any one of Session Management Function (SMF), Access and Mobility Management Function (AMF), Policy Control Function (PCF), User Plane Function (UPF), Unified Data Management (UDM), Network Exposure Function (NEF), Network Repository Function (NRF), Charging Function (CHF), Network Slice Selection Function (NSSF), Application Function (AF), Authentication Server Function (AUSF), Service Communication Proxy (SCP), Unstructured Data Storage Function (UDSF), context storage, Operation Administration Maintenance (OAM), Element Management System (EMS), configuration server, and identifier management server. As described above, the network entity according to an embodiment of the present disclosure includes a hardware configuration for supporting multiple multi-path QUIC protocols, and in particular, when operating as a session management function, can provide an optimized access traffic steering function to the user terminal considering the protocol data unit session type and the capability of the network.

FIG. 6 is a block diagram illustrating a configuration of a user terminal according to an embodiment of the present disclosure. Terms such as '~unit', '~er', etc. used below mean a unit that processes at least one function or operation, which may be implemented as hardware or software, or a combination of hardware and software. Referring to FIG. 6, a user terminal 600 according to an embodiment of the present disclosure may include a transceiver 610, a memory 620, and a processor 630. The transceiver 610 may perform functions for transmitting and receiving signals through a wireless channel. For example, the transceiver 610 may perform a conversion function between a baseband signal and a bit stream according to the physical layer standard of the system. During data transmission, the transceiver 610 may generate complex symbols by encoding and modulating a transmission bit stream. During data reception, the transceiver 610 may recover a reception bit stream through demodulation and decoding of a baseband signal. In addition, the transceiver 610 may up-convert a baseband signal into an RF band signal and transmit it through an antenna, and down-convert an RF band signal received through an antenna into a baseband signal. In one embodiment, the transceiver 610 may include a transmission filter, a reception filter, an amplifier, a mixer, an oscillator, a digital-to-analog converter (DAC), an analog-to-digital converter (ADC), etc. Also, the transceiver 610 may include a plurality of transmission/reception paths. Furthermore, the transceiver 610 may include at least one antenna array composed of a plurality of antenna elements. In terms of hardware, the transceiver 610 may be composed of a digital circuit and an analog circuit (e.g., radio frequency integrated circuit (RFIC)). Here, the digital circuit and the analog circuit may be implemented as one package. Also, the transceiver 610 may include a plurality of RF chains. Furthermore, the transceiver 610 may perform beamforming. The transceiver 610 may include a transmitter 611 and a receiver 613, which may be collectively referred to as a transceiver. The transceiver 610 may transmit and receive signals with a Radio Access Network (RAN), Access and Mobility Management Function (AMF), Session Management Function (SMF), etc.

In one embodiment, the transceiver 610 may transmit access traffic steering capability information to the session management function. The access traffic steering capability information may be composed of a combination including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E). In one embodiment, the transceiver 610 may receive an access traffic steering parameter from the session management function. The access traffic steering parameter may include ATSSS rules, MPQUIC network steering functionalities information, Measurement assistance information, etc. In one embodiment, the transceiver 610 may transmit and receive data through 3GPP access and Non-3GPP access. The transceiver 610 may transmit and receive data while performing traffic steering, switching, or splitting between two accesses based on the access traffic steering parameter.

The memory 620 may store data such as basic programs, application programs, and configuration information for the operation of the user terminal 600. The memory 620 may be composed of volatile memory, non-volatile memory, or a combination of volatile memory and non-volatile memory. And, the memory 620 may provide stored data according to the request of the processor 630. In one embodiment, the memory 620 may store program codes for supporting multiple multi-path QUIC protocols. The memory 620 may store capability information related to ATSSS steering functionality supported by the user terminal, ATSSS rules, access traffic steering parameters, etc. In one embodiment, the memory 620 may store PDU session type information, ATSSS-ST information, MPQUIC network steering functionalities information, Measurement assistance information, etc.

The processor 630 may control the overall operations of the user terminal 600. For example, the processor 630 may transmit and receive signals through the transceiver 610. Also, the processor 630 may record and read data in the memory 620. The processor 630 may perform functions of the protocol stack required by the communication standard. To this end, the processor 630 may include at least one processor or microprocessor, or may be part of a processor. Also, a part of the transceiver 610 and the processor 630 may be referred to as a Communication Processor (CP). The processor 630 may control the user terminal 600 to perform any one of the operations of various embodiments of the present disclosure. Specifically, the processor 630 may control to perform the operating method of the user terminal shown in FIG. 4.

In one embodiment, the processor 630 may control to transmit access traffic steering capability information including one or more of Access Traffic Steering, Switching, Splitting Low-Layer (ATSSS-LL), Multi-Path Transmission Control Protocol (MPTCP), Multi-Path Quick UDP Internet Connections - User Datagram Protocol (MPQUIC-UDP), Multi-Path Quick UDP Internet Connections - Internet Protocol (MPQUIC-IP), and Multi-Path Quick UDP Internet Connections - Ethernet (MPQUIC-E) as supportable access traffic steering functionalities to the session management function. In one embodiment, the processor 630 may control to transmit by including the access traffic steering capability information in a PDU Session Establishment Request or PDU Session Modification Request. The access traffic steering capability information may be included in ATSSS-ST of 5GSM capability or ATSSS PCO of Extended PCO. In one embodiment, the processor 630 may control to select an appropriate access traffic steering function combination according to the protocol data unit session type. If the protocol data unit session type is one of IPv4, IPv6, or IPv4v6, the processor 630 may control to select a combination including one or more of MPTCP, MPQUIC-UDP, and MPQUIC-IP. On the other hand, if the protocol data unit session type is Ethernet, the processor 630 may control to select a combination including MPQUIC-E.

If the protocol data unit session type is one of IPv4, IPv6, or IPv4v6, the processor 630 may control to select a combination including at least one of ATSSS-LL, MPTCP, MPQUIC-UDP, or MPQUIC-IP. On the other hand, if the protocol data unit session type is Ethernet, the processor 630 may control to select a combination including at least one of ATSSS-LL or MPQUIC-E.

In one embodiment, the processor 630 may control to receive an access traffic steering parameter from the session management function. The access traffic steering parameter may be received through a PDU Session Establishment Accept or PDU Session Modification Command message. In one embodiment, the processor 630 may control to interpret ATSSS rules included in the access traffic steering parameter. The processor 630 may control to check whether the Steering functionality included in the ATSSS rules indicates any one of MPTCP, MPQUIC-UDP, MPQUIC-IP, MPQUIC-E, and ATSSS-LL. In one embodiment, the processor 630 may control to establish a MPQUIC connection using MPQUIC network steering functionalities information included in the access traffic steering parameter. The MPQUIC network steering functionalities information may include one or more of MPQUIC-UDP network steering functionalities information, MPQUIC-IP network steering functionalities information, and MPQUIC-E network steering functionalities information. In one embodiment, the processor 630 may control to establish a connection with a proxy server using Proxy type, Proxy IP address, Proxy port, Client 3GPP IP address, and Client Non-3GPP IP address included in the MPQUIC network steering functionalities information. The Proxy type may indicate one of MPTCP, MPQUIC-UDP, MPQUIC-IP, and MPQUIC-E.

In one embodiment, the processor 630 may control to perform traffic steering, switching, or splitting between 3GPP access and Non-3GPP access based on the access traffic steering parameter. In one embodiment, the processor 630 may control to perform traffic processing according to the Steering mode included in the ATSSS rules. The Steering mode may be one of Active-Standby, Smallest Delay, Load-Balancing, Priority-based, and Redundant. In one embodiment, if it is Active-Standby mode, the processor 630 may control to preferentially use the active access network and use the standby access network when the active access network is unavailable. In one embodiment, if it is Smallest Delay mode, the processor 630 may control to use an access network with a smaller Round-Trip Time (RTT) between the user terminal and the user plane function. In one embodiment, if it is Load-Balancing mode, the processor 630 may control to use two access networks at a certain ratio. In one embodiment, if it is Priority-based mode, the processor 630 may control to preferentially use an access network with high priority and use an access network with low priority together when the corresponding access network is congested. In one embodiment, if it is Redundant mode, the processor 630 may control to replicate traffic and use both access networks.

In one embodiment, when using ATSSS-LL, the processor 630 may control to perform performance measurement using Measurement assistance information included in the access traffic steering parameter. The processor 630 may control to measure Round-Trip Time (RTT), Packet Loss Rate (PLR), and Access Availability/Unavailability in cooperation with the PMF of the user plane function. In one embodiment, the processor 630 may control to communicate with the PMF of the user plane function using PMF IP address, PMF Port, or PMF MAC address included in the Measurement assistance information. In the case of an Ethernet protocol data unit session, 3GPP MAC address and Non-3GPP MAC address can be used, and in the case of an Internet protocol protocol data unit session, 3GPP Internet protocol address and Non-3GPP Internet protocol address and port can be used.

The transceiver 610 and the processor 630 do not necessarily have to be implemented as separate modules, and of course, can be implemented as a single component in the form of a single chip or software block. The transceiver 610, memory 620, and processor 630 may be electrically connected. As described above, the user terminal according to an embodiment of the present disclosure includes a hardware configuration for supporting multiple multi-path QUIC protocols, and can perform optimized traffic processing between3GPP access and Non-3GPP access based on the access traffic steering parameter received from the session management function.

The methods according to the embodiments described in the claims or specification of the present disclosure may be implemented in the form of hardware, software, or a combination of hardware and software. When implemented in software, a computer-readable storage medium storing one or more programs (software modules) may be provided. One or more programs stored in the computer-readable storage medium are configured for execution by one or more processors in an electronic device. The one or more programs include instructions causing the electronic device to execute the methods according to the embodiments described in the claims or specification of the present disclosure. Such a program (software module, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, and magnetic cassette. Or, it may be stored in a memory composed of a combination of some or all of these. Also, each configuration memory may be included in plurality. In addition, the program may be stored in an attachable storage device that can be accessed through a communication network such as Internet, Intranet, Local Area Network (LAN), Wide Area Network (WAN), or Storage Area Network (SAN), or a communication network composed of a combination thereof. Such a storage device may connect to a device performing an embodiment of the present disclosure through an external port. Also, a separate storage device on a communication network may connect to a device performing an embodiment of the present disclosure.

In the specific embodiments of the present disclosure described above, components included in the disclosure are expressed in singular or plural according to the specific embodiment presented. However, the singular or plural expression is selected appropriately for the presented situation for convenience of description, and the present disclosure is not limited to singular or plural components, and even if a component is expressed in plural, it may be composed of singular, or even if a component is expressed in singular, it may be composed of plural. Meanwhile, although specific embodiments have been described in the detailed description of the present disclosure, it goes without saying that various modifications are possible within the scope not departing from the scope of the present disclosure. Therefore, the scope of the present disclosure should not be limited to the described embodiments and should be determined by the claims described below as well as equivalents to these claims.

What is claimed is:

1. A method of operating a Session Management Function (SMF) for supporting a Multi-path Quick UDP Internet Connections (QUIC) protocol in a wireless communication system, the method comprising:
receiving information including at least one of Access Traffic Steering, Switching, Splitting Low-Layer (ATSSS-LL), Multi-Path Transmission Control Protocol (MPTCP), Multi-Path Quick UDP Internet Connections over User Datagram Protocol (MPQUIC-UDP), Multi-Path Quick UDP Internet Connections over Internet Protocol (MPQUIC-IP), or Multi-Path Quick UDP Internet Connections over Ethernet (MPQUIC-E) as an access traffic steering capability or an access traffic steering protocol configuration option from a User Equipment (UE);
determining an access traffic steering functionality to be provided to the user equipment based on at least one of a Protocol Data Unit (PDU) session type, a User Equipment (UE) capability or a capability of a network; and providing an access traffic steering parameter corresponding to the determined access traffic steering functionality to the user equipment,
wherein the access traffic steering parameter includes at least one of a proxy type, a proxy Internet Protocol address type, a proxy Internet Protocol address, a proxy port, a client 3rd Generation Partnership Project (3GPP) Internet Protocol address type, a client 3rd Generation Partnership Project (3GPP) Internet Protocol address, a client Non-3rd Generation Partnership Project (Non-3GPP) Internet Protocol address type, or a client Non-3rd Generation Partnership Project (Non-3GPP) Internet Protocol address.

2. The method of claim 1, wherein the proxy type is represented by any one value of: 1 indicating a Multi-Path Transmission Control Protocol proxy, 2 indicating a Multi-Path Quick UDP Internet Connections over User Datagram Protocol proxy, 3 indicating a Multi-Path Quick UDP Internet Connections over Internet Protocol proxy, or 4 indicating a Multi-Path Quick UDP Internet Connections over Ethernet proxy.

3. The method of claim 1, wherein the proxy Internet Protocol address includes one or more IPv4 addresses, one or more IPv6 addresses, or one or more IPv4 addresses and one or more IPv6 addresses.

4. The method of claim 1, further comprising receiving the information from the user equipment as either a protocol data unit session establishment request or a protocol data unit session modification request.

5. The method of claim 1, wherein the SMF selects a combination including at least one of Access Traffic Steering, Switching, Splitting Low-Layer (ATSSS-LL), or Multi-Path Transmission Control Protocol (MPTCP), Multi-Path Quick UDP Internet Connections over User Datagram Protocol (MPQUIC-UDP), or Multi-Path Quick UDP Internet Connections over Internet Protocol (MPQUIC-IP) when the protocol data unit session type is one of IPv4, IPv6, or IPv4v6, or selects a combination including at least one of Access Traffic Steering, Switching, Splitting Low-Layer (ATSSS-LL), or Multi-Path Quick UDP Internet Connections over Ethernet (MPQUIC-E) when the protocol data unit session type is Ethernet.

6. A method of operating a User Equipment (UE) for supporting a Multi-path Quick UDP Internet Connections (QUIC) protocol in a wireless communication system, the method comprising:
transmitting access traffic steering capability information including at least one of Access Traffic Steering, Switching, Splitting Low-Layer (ATSSS-LL), Multi-Path Transmission Control Protocol (MPTCP), Multi-Path Quick UDP Internet Connections over User Datagram Protocol (MPQUIC-UDP), Multi-Path Quick UDP Internet Connections over Internet Protocol (MPQUIC-IP), or Multi-Path Quick UDP Internet Connections over Ethernet (MPQUIC-E) as supportable access traffic steering functionalities to a Session Management Function (SMF);
receiving an access traffic steering parameter from the session management function; and performing traffic steering, switching, or splitting between a 3rd Generation Partnership Project (3GPP) access and a Non-3GPP access based on the access traffic steering parameter,
wherein the access traffic steering parameter includes at least one of a proxy type, a proxy Internet Protocol address type, a proxy Internet Protocol address, a proxy port, a client 3GPP Internet Protocol address type, a client 3GPP Internet Protocol address, a client Non-3GPP Internet Protocol address type, or a client Non-3GPP Internet Protocol address.

7. The method of claim 6, wherein the proxy type is represented by any one value of: 1 indicating a Multi-Path Transmission Control Protocol proxy, 2 indicating a Multi-Path Quick UDP Internet Connections over User Datagram Protocol proxy, 3 indicating a Multi-Path Quick UDP Internet Connections over Internet Protocol proxy, or 4 indicating a Multi-Path Quick UDP Internet Connections over Ethernet proxy.

8. The method of claim 6, wherein the proxy Internet Protocol address includes one or more IPv4 addresses, one or more IPv6 addresses, or one or more IPv4 addresses and one or more IPv6 addresses.

9. The method of claim 6, further comprising transmitting the information to the session management function as either a protocol data unit session establishment request or a protocol data unit session modification request.

10. A Session Management Function (SMF) for supporting a Multi-path Quick UDP Internet Connections (QUIC) protocol in a wireless communication system, the session management function comprising:
a transceiver; and
a processor operably connected to the transceiver, wherein the processor is configured to:
receive information including at least one of Access Traffic Steering, Switching, Splitting Low-Layer (ATSSS-LL), Multi-Path Transmission Control Protocol (MPTCP), Multi-Path Quick UDP Internet Connections over User Datagram Protocol (MPQUIC-UDP), Multi-Path Quick UDP Internet Connections over Internet Protocol (MPQUIC-IP), or Multi-Path Quick UDP Internet Connections over Ethernet (MPQUIC-E) as an access traffic steering capability or an access traffic steering protocol configuration option from a User Equipment (UE);
determine an access traffic steering functionality to be provided to the user equipment based on at least one of a Protocol Data Unit (PDU) session type, a User Equipment (UE) capability or a capability of a network; and provide an access traffic steering parameter corresponding to the determined access traffic steering functionality to the user equipment,
wherein the access traffic steering parameter includes at least one of a proxy type, a proxy Internet Protocol address type, a proxy Internet Protocol address, a proxy port, a client 3rd Generation Partnership Project (3GPP) Internet Protocol address type, a client 3rd Generation Partnership Project (3GPP) Internet Protocol address, a client Non-3rd Generation Partnership Project (Non-3GPP) Internet Protocol address type, or a client Non-3rd Generation Partnership Project (Non-3GPP) Internet Protocol address.

11. The session management function of claim 10, wherein the proxy type is represented by any one value of: 1 indicating a Multi-Path Transmission Control Protocol proxy, 2 indicating a Multi-Path Quick UDP Internet Connections over User Datagram Protocol proxy, 3 indicating a Multi-Path Quick UDP Internet Connections over Internet Protocol proxy, or 4 indicating a Multi-Path Quick UDP Internet Connections over Ethernet proxy.

12. The session management function of claim 10, wherein the proxy Internet Protocol address includes one or more IPv4 addresses, one or more IPv6 addresses, or one or more IPv4 addresses and one or more IPv6 addresses.

13. The session management function of claim 10, wherein the processor is configured to receive the information from the user equipment as either a protocol data unit session establishment request or a protocol data unit session modification request.

14. The session management function of claim 10, wherein the processor is configured to select a combination including at least one of Access Traffic Steering, Switching, Splitting Low-Layer (ATSSS-LL), or Multi-Path Transmission Control Protocol (MPTCP), Multi-Path Quick UDP Internet Connections over User Datagram Protocol (MPQUIC-UDP), or Multi-Path Quick UDP Internet Connections over Internet Protocol (MPQUIC-IP) when the protocol data unit session type is one of IPv4, IPv6, or IPv4v6, or select a combination including at least one of Access Traffic Steering, Switching, Splitting Low-Layer (ATSSS-LL), or Multi-Path Quick UDP Internet Connections over Ethernet (MPQUIC-E) when the protocol data unit session type is Ethernet.
